(19) United States
(12) Patent Application Publication
(10) Pub. No.: US 2009/0272190 A1
(43) Pub. Date: Nov. 5, 2009

(54) FLOW METHODS AND APPARATUS FOR DETECTION IN CONDUITS

(75) Inventor: Martin John Hofmann, Gloucestershire (GB)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hills, NY (US)

(21) Appl. No.: 11/721,367

(22) PCT Filed: Dec. 30, 2005
(86) PCT No.: PCT/EP05/14152

§ 371 Date: Jun. 11, 2007

(30) Foreign Application Priority Data
Dec. 31, 2004 (GB) 0428545.8

(51) Int. Cl. G01N 29/032

(52) U.S. Cl. 73/599

(57) ABSTRACT

A method for measuring one or more parameters in a fluid in a flow conduit using ultrasound is disclosed, the method comprising transmitting ultrasound signals at a frequency in the range of from about 100 kHz to about 30,000 kHz through the fluid, measuring the amplitude attenuation of the ultrasound signals having passed through the fluid, and using the measured attenuation to measure a parameter in the fluid.

### BACKGROUND OF THE INVENTION

The present invention relates to methods and apparatus for observing properties and processes, e.g., measuring one or more parameters of or in a flowable material, in a flow conduit using ultrasound, and particularly relates to monitoring the one or more parameters of or in a fluid in a conduit using ultrasound, e.g., to determine the presence and/or formation of agglomerates within the fluid and/or monitoring fermentation in the conduit.

Monitoring, inspection and detection of the properties of materials flowing through a pipe, without needing to remove a sample from the pipe for analysis, are important in numerous industries. Examples include monitoring the quality of a product in the pharmaceutical industry or the quality of oil in a pipeline in the oil industry and monitoring of blood or blood fractionation liquids.

Currently, the properties of materials flowing through a pipe can be monitored by ultraviolet (UV) spectroscopy or conductivity measurements. Even though these measurements can be made without extracting samples from the pipe, it is still necessary to provide UV-transparent windows or electrodes in the pipe. This limits the points at which measurements can be taken as the UV windows or electrodes may only be present in certain fixed portions of the pipe. Also, these may require regular replacement or cleaning to keep the measurements accurate. This may necessitate stopping the fluid flow which is inefficient in large production or transportation processes.

Furthermore, methods such as UV spectroscopy and conductivity measurements, can only be used for certain classes of flowing material. For example, UV spectroscopy can only be used for materials with an appropriate UV chromophore and transparent to light, and conductivity measurements can only be used for materials which are at least partially conductive.

At present, pressure changes in a fluid flowing through a conduit are typically measured by pressure transducers which are in contact with the fluid flow. This presents similar problems to the measurement of the UV spectrum or conductivity of the fluid, and the pressure transducer can only operate at points where specially manufactured sections of conduit are in place to allow insertion of the transducer.

While ultrasound has been used to measure certain properties of flowing materials, this has been problematic in that it also requires measurement of the temperature of the fluid. This means either that the temperature probe is inserted directly into the fluid, requiring specially manufactured conduits, or the probe is placed on the outside of the conduit where the reading of the fluid temperature may be inaccurate.

### BRIEF SUMMARY OF THE INVENTION

In one embodiment, the present invention relates to a non-invasive method of measuring one or more parameters in a fluid flowing through a conduit, the method comprising transmitting ultrasound signals at a frequency in the range of from about 100 kHz to about 30,000 kHz through the fluid; measuring the amplitude attenuation of the ultrasound signals having passed through the fluid; and using the measured attenuation to measure a parameter in the fluid.

An embodiment of the method includes determining the change in amplitude attenuation of the ultrasound signals over time, and relating this change to a change in one or more parameters in the fluid.

Preferred embodiments of the method include measuring, more preferably, monitoring, one or more of: agglomerates, solutes, particulates, and precipitates in the fluid in the conduit. Additionally, or alternatively, embodiments of the method include measuring, more preferably, monitoring, fermentation in the fluid in the conduit.

Embodiments of the invention can be carried out using a variety of conduits, e.g., a “reusable” conduit such as a metal conduit, or a “disposable” conduit such as a plastic conduit.

### BRIEF DESCRIPTION OF THE SEVERAL VIEWS OF THE DRAWING(S)

FIG. 1 shows a longitudinal cross section of an embodiment of a flow conduit with an ultrasound transceiver alongside it.

FIG. 1A shows a longitudinal cross section of another embodiment of a flow conduit with an ultrasound transceiver alongside it.

FIG. 2 shows a diametric cross section of a flow conduit through II-II of FIG. 1.

FIG. 2A shows a diametric cross section of a flow conduit through IIA-IIA of FIG. 1A.

FIG. 3 shows a perspective view of an embodiment of a conduit with an ultrasound emitter unit attached to it.

FIG. 4 shows a cross section, along IV-IV of FIG. 3, of a conduit with an ultrasound emitter unit attached to it.

FIG. 5 shows the variation in amplitude attenuation of an ultrasound signal with time used to detect the concentration of a species in a conduit.

FIG. 6 shows using ultrasound to detect small concentrations of acetone in a conduit.

FIG. 7 shows the relationship between ultrasound attenuation and acetone concentration, wherein acetone, at low concentrations, passes through a column.

### DETAILED DESCRIPTION OF THE INVENTION

In one embodiment, the present invention relates to a non-invasive method of measuring one or more parameters in a fluid flowing through a conduit, the method comprising transmitting ultrasound signals at a frequency in the range of from about 100 kHz to about 30,000 kHz through the fluid; measuring the amplitude attenuation of the ultrasound signals having passed through the fluid; and using the measured attenuation to measure a parameter in the fluid.

An embodiment of the method includes determining the change in amplitude attenuation of the ultrasound signals over time, and relating this change to a change in one or more parameters in the fluid.

An embodiment of the method comprises measuring, more preferably, monitoring, one or more of (in some more preferred embodiments, monitoring two or more of): fluid pressure, solute concentration, solid particulate concentration, purity of target molecule, and detection of target molecule, in the conduit.

Preferred embodiments of the method include measuring, more preferably, monitoring, one or more of (in some embodiments, two or more of): agglomerates, solutes, particulates, and precipitates, in the fluid in the conduit. Additionally, or alternatively, embodiments of the method include measuring, more preferably, monitoring, fermentation in the fluid in the conduit.

In some embodiments, the method can be carried out without significantly reducing the presence of bubbles and/or foam in the conduit.

Embodiments of the invention can be carried out using a variety of conduits, e.g., a “reusable” conduit such as a metal conduit, or a “disposable” conduit such as a plastic conduit.

The change in the ultrasound signal after passing through the fluid in the conduit may be a change over space, i.e., at different locations along the conduit measured at the same time, a change over time, i.e., at different times but the same location along the conduit, or a mixture of both. Preferably, the change in the ultrasound signal is a change over time recorded at the same location on the conduit.

The change in ultrasound signal may be either a change in the time of flight of the signal through the fluid, or a change in the amplitude attenuation of the ultrasound signal. Preferably, it is a change in the amplitude attenuation of the ultrasound signal. If the change in ultrasound signal is a change in the time of flight of the signal, adjustments must usually be made to account for the temperature of the fluid.

The fluid in the conduit may be a liquid, a gas, a liquid/solid mixture or suspension, a flowable solid, or a mixture of any of these. The fluid can include, for example, one or more of: solutes, particulates, precipitates, flocculates, sols, suspensions, micelles, emulsions, and a mixture of any of these.

The conduit may be in fluid communication with, for example, a variety of apparatus or devices, e.g., one or more of a chromatography column, a filter device, and a vessel. A variety of suitable apparatus and devices are known in the art. The vessel may be, for example, a reaction vessel, such as a fermentor, a bioreactor, or a chemical or pharmaceutical reaction vessel; a storage vessel, e.g., for oil, pharmaceuticals, filtrate, retentate, foodstuffs, water, fuels, fuel gases such as hydrogen or natural gas, chemicals, or fluid waste; a mixing vessel, such as a reacting emulsion as used in making chromatography media; a separation vessel; a crystallisation vessel; or a blood fractionation vessel. The vessel can be made of any suitable material, e.g., metal (for example, stainless steel) or plastic (e.g., a deformable material such as at least one of polypropylene, polyethylene, silicone, an acrylic resin, and polyvinyl chloride, e.g., forming a bag). A variety of suitable vessels, e.g., for receiving and/or containing a flowable material (e.g., a fluid), are known in the art.

In one embodiment, the present invention utilises the attenuation of the amplitude of an ultrasound signal to determine properties of the material inside the conduit. This avoids the need for a temperature probe, as the amplitude attenuation is found not to depend significantly on the temperature of the fluid. This allows apparatus to be manufactured which is easily moveable to different places on a conduit as it is not limited to being used only with a specially adapted conduit.

Furthermore, embodiments of the present invention do not require a reference cell with which to compare the ultrasound response of the material to be measured.

Embodiments of the present invention also enable measuring, more preferably, monitoring, the pressure of a fluid flowing through a conduit.

Furthermore, the ultrasound signal (e.g., a lower frequency ultrasound signal) can penetrate the walls of metal conduits such as steel conduits, e.g., large diameter water pipes. This is particularly useful as it allows observation of parameters within conduits in which measurements such as conductivity or UV or visible spectra can not be recorded in-situ.

In a preferred embodiment, the one or more parameters (in some embodiments, the two or more parameters) in the fluid is or are selected from physical parameters such as fluid pressure, solute concentration, solid particulate concentration, presence of agglomerates, nature of solute (e.g., proteins give different ultrasound responses to salts and acetone), structural characteristics of solid particulates in a flowable material, e.g., the size and/or morphology of crystals, purity of target molecule(s), detection of target molecules in a flow in order to time the collection of the target molecule(s) further downstream, fitness for use (e.g., food edibility, etc.), observation of blood and haemodialysis liquids and blood fractions, e.g., Cohn fractions.

A process may be taking place in the fluid, at or upstream of the measurement location. The processes in the fluid (and thus, one or more monitorable parameters in the fluid being processed) are preferably selected from, for example, fermentation, filtration, chemical synthesis, crystallisation, chromatography, degradation of foodstuffs, and contamination of a liquid or liquid/solid mixture.

The mode of transmitting an ultrasound signal through the fluid in the conduit may include attachment of an ultrasound emitter (that can be an ultrasound transceiver) to the outside of the conduit and transmission of an ultrasound signal through a wall of the conduit, inclusion of an ultrasound emitter into a wall of the conduit spatially isolated from the fluid in the conduit, or transmission of an ultrasound signal from an ultrasound emitter via an ultrasound transmissive material through a wall of the conduit. In those embodiments also including the use of a separate ultrasound receiver, the receiver can be attached as described above with respect to the ultrasound emitter.

The ultrasound signal is transmitted into the fluid in the conduit by an ultrasound emitter which is not in direct contact with the fluid in the conduit. Preferably the ultrasound emitter is attached to the outside of the conduit and transmits the ultrasound signal through a wall of the conduit. Even more preferably, the ultrasound signal is transmitted from the ultrasound emitter to a wall of the conduit by an ultrasound transmissive material there between. In preferred embodiments, the ultrasound emitter (and ultrasound receiver, if present) is removably attached to the outside surface of the conduit.

Another embodiment of the present invention relates to apparatus for use in a method for measuring, more preferably, monitoring, a change in one or more parameters, e.g., physical parameters, of a fluid in a flow conduit, comprising a flow conduit having a wall with an external ultrasound emitter socket having a transmission face separated by a wall layer from the adjacent inner surface of the flow conduit, and an ultrasound emitter in said ultrasound emitter socket and arranged to emit an ultrasound signal towards said flow conduit.

Preferably the transmission face of the ultrasound emitter socket is complementary to the ultrasound emitter. In an embodiment, the transmission face is substantially flat.

In an embodiment, the apparatus has an ultrasound transmissive material interposed between the transmission face of the ultrasound emitter socket and the ultrasound emitter and/or transceiver and/or receiver.

In one embodiment, the apparatus also comprises an optional ultrasound reflector inside the flow conduit opposed to the transmission face of the ultrasound emitter socket across the flow conduit. In this embodiment, the ultrasound reflector is the internal surface of the conduit wall. In some embodiments, the internal surface of the conduit wall is substantially flat and substantially parallel to the transmission face of the ultrasound emitter socket.

In an embodiment, the flow conduit and ultrasound emitter socket are integrally formed as a single-piece unit.

As used herein, the term “single-piece” refers to a unit formed from one piece of material with no joins in its construction.

As ultrasonic signals are reflected from interfaces between pieces of material, the use of a single-piece apparatus minimises unwanted reflections of the ultrasound signal caused by joins in the apparatus. This provides a clearer and stronger signal received by the ultrasound receiver than if an apparatus with joints, providing unwanted ultrasound reflection regions, is used. For a similar reason, in those embodiments including an ultrasound reflector, a single-piece apparatus provides a clearer and stronger signal reflected from the ultrasound reflector back to the ultrasound receiver.

In an embodiment of the apparatus, the ultrasound emitter can be an ultrasound transceiver.

A variety of ultrasound emitters, transceivers, and receivers are suitable for use in the invention. In one embodiment, a CLAD ultrasonic transceiver, comprising a core and cladding (acting as a collimator), can be used. Such a device, that reduces or eliminates spurious ultrasonic noises, can be especially desirable for use with a disposable plastic (e.g., polyethylene) conduit, wherein the disposable conduit moves during monitoring, e.g., wherein the conduit is connected to a vessel containing flowable material that is placed on a rocker or agitator. One example of a CLAD transceiver is marketed by Synthesarc, Inc. (Quebec, Canada).

Typically, the apparatus is made from formable engineering materials, for example, metals, such as steel, aluminum or titanium, plastics materials or polymers, such as polyetheretherketone (PEEK), polypropylene, or polymethacrylate.

The flow conduit can be made from any suitable material, e.g., metal (for example, stainless steel) or plastic (e.g., a deformable material such as one or more of polypropylene, polyethylene, silicone, an acrylic resin, and polyvinyl chloride (PVC)). A variety of suitable conduits, including “reusable” conduits (e.g., metal conduits) or “disposable” conduits (e.g., plastic conduits) are known in the art.

In some embodiments of the invention, the flow conduit has a transverse dimension, e.g., diameter (or largest diameter, where non-circular), of between about 2 mm to about 10,000 mm, or more. For example, the flow conduit can have a diameter of from about 2 mm to about 6 mm, from about 10 mm to about 50 mm, or from about 60 mm to about 150 mm, or more.

In other embodiments, the flow conduit has a diameter of from about 12 mm and about 10,000 mm (10 m), in some embodiments, between about 12 mm and about 2000 mm (2 m), between about 12 mm and about 200 mm, or about 200 mm to about 2000 mm.

Typically, embodiments of methods and apparatus according to the invention utilise ultrasound signals with a frequency of about 100 kHz to about 30 MHz (30,000 kHz), more typically, in the range of from about 500 kHz to about 25 MHz (25,000 kHz). For example, in some embodiments of the invention, the ultrasound signals have a frequency of about 1,000 kHz to about 30,000 kHz, a frequency of about 500 kHz to about 20,000 kHz, a frequency of about 2,000 kHz to about 25,000 kHz, a frequency of about 1,000 kHz to about 20,000 kHz, or about 2,000 kHz to about 30,000 kHz.

For example, in some embodiments wherein the conduit is a re-usable conduit such as a metal (e.g., stainless steel) conduit, or a disposable conduit such as a plastic (e.g., polyethylene, polypropylene, PVC, and/or silicone) conduit, having a diameter of about 2 mm to about 6 mm, the frequency of the ultrasound signal is typically about 2,000 kHz to about 30,000 kHz.

In some other embodiments wherein the conduit is a re-usable conduit such as a metal conduit, or a disposable conduit such as a plastic conduit, having a diameter of about 10 mm to about 50 mm, the frequency of the ultrasound signal is typically about 1,000 kHz to about 25,000 kHz.

In yet some other embodiments wherein the conduit is a re-usable conduit such as a metal conduit, or a disposable conduit such as a plastic conduit, having a diameter of about 60 mm to about 150 mm, the frequency of the ultrasound signal is typically about 500 kHz to about 20,000 kHz.

In still yet some other embodiments wherein the conduit is a re-usable conduit such as a metal conduit, or a disposable conduit such as a plastic conduit, having a diameter of at least about 175 mm, e.g., about 200 mm to about 2000 mm, or more, the frequency of the ultrasound signal is typically about 100 kHz to about 25,000 kHz.

Some other embodiments of the present invention utilise ultrasound signals with a frequency of about 100 kHz to about 30 MHz (30,000 kHz), e.g., about 500 kHz to about 30 MHz, for measurements of fluids in conduits with a diameter of greater than about 10 mm, in some embodiments, between about 10 mm and about 10 m (10,000 mm).

In another embodiment of the invention, the frequency of the ultrasound signal is between about 100 kHz and about 1 MHz, e.g., between about 100 kHz and about 250 kHz for paths, such as the transverse dimension, e.g., diameter, of the conduit over 500 mm, in some embodiments, over 800 mm, e.g., 2000 mm, or over. Alternatively, the frequency of the ultrasound signal can be between about 1 MHz and about 10 MHz, e.g., about 1 MHz to about 30 MHz, when the path, such as the transverse dimension, e.g., diameter, of the conduit is between 12 mm and 500 mm.

The lower frequency ultrasound signal, e.g., 100 to 500 kHz, can be used to observe a parameter over longer pathlengths, e.g., 2000 mm, whereas the higher frequency ultrasound signal, e.g., 1 MHz, is less effective in observing parameters over longer pathlengths, e.g., above 2000 mm.

In an embodiment, the invention provides an ultrasound emitter unit comprising a mounting block with a conduit interface surface with an opening in it to allow an ultrasound signal from the ultrasound emitter to be emitted out of the conduit interface surface without passing through the mounting block. Preferably there is an ultrasound transmission space for couplant between the ultrasound emitter and the surface of a conduit when the ultrasound emitter unit is in place on the surface of the conduit. Preferably the ultrasound emitter unit also comprises means for attaching the mounting block to a conduit. A variety of mounting blocks and means for attaching the mounting blocks are suitable for use in the invention.

Preferably, the ultrasound emitter unit also comprises an access hole into the ultrasound transmission space allowing it to be filled with ultrasound transmissive material (couplant) when the mounting block is in place on the surface of a conduit. In this embodiment, an ultrasound emitter is preferably sealed into a socket in the mounting block by a seal, e.g., by an O-ring seal, which is either set into the ultrasound emitter and provides a sealing interface against a smooth wall of the socket, or set into the wall of the socket and provides a sealing interface against a smooth surface of the ultrasound emitter.

Preferably the emitter is arranged to emit an ultrasound signal towards the conduit on which the ultrasound emitter unit is mounted.

The ultrasound transmission space preferably contains an ultrasound transmissive material (the couplant), e.g., held in place with, for example, a film, such as a plastic film. This material may be, e.g., water, other liquid, or ultrasound transmissive paste or gel. A variety of ultrasound transmissive materials are suitable. Preferably, the ultrasound transmissive gel is a polyalcohol, e.g., with either ketone or aldehyde substituents. It may be a proprietary product from Pall Euroflow, Ltd.

By conforming exactly and filling the interface between the components, this ultrasound transmissive material ensures efficient communication of the ultrasound signal from the ultrasound emitter which is set in the socket, and the surface of the conduit on which the unit is mounted.

Preferably, the conduit interface surface has a seal on it which seals against the surface of the conduit against which the ultrasound emitter unit is fixed. This seal ensures that the ultrasound transmissive material does not escape from the ultrasound transmission volume where the mounting block meets the conduit. Preferably the seal is formed from a resilient material such as rubber or foam. More preferably this seal forms a watertight seal between the conduit and the mounting block.

In general, the ultrasound emitter unit according to an embodiment of the invention may be attached to various different diameters of conduit. In a preferred embodiment, where the unit also comprises a resilient seal on the conduit interface surface, the resilient seal deforms to accommodate various surface curvatures and therefore allows attachment of the unit to many different diameters of conduit.

The means for attaching the mounting block to a conduit may comprise any temporary or permanent means. Temporary means may include, for example, one or more straps, springs, clamps or brackets passing around or through the ultrasound emitter unit and attaching around or to the conduit, magnetic fixing means, screws or bolts passing through the ultrasound emitter unit and attaching to the conduit, or hook and eye fixings. Permanent means may include, for example, adhesive, welding, or soldering.

In the apparatus of some of the embodiments of the present invention, the generation of the ultrasound signal is controlled by signal generation apparatus connected to the ultrasound emitter. This signal generation apparatus may control such parameters as the duration of each pulse, the frequency of occurrence of the pulses, the power of each pulse, and parameters which depend on the size of conduit through which the ultrasound signal is passed and the frequency of the ultrasound, e.g., to obtain a 100 kHz signal, a pulse of up to 1000 volt is typically used, whereas a 1 MHz signal can be obtained with, for example, a 300 volt pulse.

The ultrasound signal which has passed through the fluid flowing through the conduit can be analysed by signal processing apparatus, for example, standard signal processing apparatus. The signal processing apparatus may include controls to select one or more of: the range of frequencies being observed, the gain of signal amplifiers, preferences for recording of the signal over time, preferences for the displaying the received signal on various output devices, alarm signals, and recording of the received signal, e.g., tracking the production of a product such as a pharmaceutical, to data logging apparatus, e.g., in accordance with one or more of the following (in some embodiments, two or more of the following): 21 CFR 11, cGAMP, GxP-related systems (e.g., Good Laboratory Practice (GLP), Good Clinical Practice (GCP), and/or Good Manufacturing Practice (GMP)), Rapid Microbiological Methods (RMM), and carrying out process validation, e.g., in accordance with Process Analytical Technology (PAT).

The signal processing apparatus may be operated remotely via, for example, RS232, USB, GPIB and/or Ethernet connection(s).

Methods of measurement, inspection and monitoring using embodiments of apparatus of the invention are in themselves further embodiments of the invention.

The methods and apparatus described may be used to detect changes in the physical properties or processes in a fluid flowing inside a conduit.

The methods and apparatus may be used particularly to measure, more preferably monitor, changes in concentration of components of a fluid flowing through a conduit. This may include monitoring one or more of (in some embodiments, monitoring two or more of): the appearance of products, target molecules, or contaminants, the disappearance of reactants, the increase or decrease in the concentration of contaminants and/or desired products in the fluid, detecting changes in the amount of solid material in a fluid flow, i.e., the liquid/solid ratio, the relative properties of miscible fluids, the presence or absence of a fluid (e.g., when an oil pipe is empty due to a leak), the presence of agglomerates, the pressure of a fluid, and a control path that will cause an alarm if the ultrasound “fingerprint” of the reaction or process is outside its normal limits (pathway).

The methods and apparatus described may also provide a negative or positive feedback mechanism wherein the ultrasound trace is monitored by a computer which has a control path with limits which when exceeded act to bring the parameters in the fluid back within the set limits, e.g., by opening a valve or other such device to provide for one or more of the following: adding a reagent, adding a diluent (e.g., water), adding buffer/acid/alkali to change the pH, and altering the temperature and/or pressure of a reaction, to bring a process back under control.

The present methods and apparatus may also be used to measure, more preferably monitor, changes in pressure of a fluid flowing through a conduit. As gases are significantly more compressible than liquids, this application is especially useful for monitoring gas flow through a conduit.

Applications for the methods and apparatus described herein may be found in a wide variety of technical fields. Examples of such applications are:
(a) measurement of changes in concentration of components or contaminants and/or pressure of the eluant and/or eluate flowing through conduits, e.g., from a chromatography column;
(b) monitoring of concentration of components or contaminants and/or pressure of fluid foodstuffs, such as milk, wine, or beer, flowing through conduits. Also, embodiments of the present invention may be used to indicate if fluid foodstuffs flowing through pipes have degraded, e.g., milk has soured;
(c) measurement of changes in concentration of components or contaminants and/or pressure of crude or other oils in oil conduits, e.g., pipelines;
(d) monitoring of changes in the concentrations of components or contaminants and/or pressure of synthetic or biosynthetic chemicals flowing through conduits before, during and/or after synthesis, for example, by fermentation processes, or continuous or batch reactor processes;
(e) monitoring of changes in concentration of contaminants and/or pressure of water, such as potable water, effluent or river water, flowing through conduits, or measurement of changes in amounts of suspended solids in water flowing through conduits;
(f) monitoring of changes in concentrations of components and/or pressure of filtration products (e.g., filtrate and/or retentate) or dialysis fluids, such as hemofiltrates, passing through conduits;
(g) monitoring of changes in concentration of components or contaminants and/or pressure of any gases, such as natural gas, flowing through a conduit;
(h) monitoring of changes in concentration and/or pressure of hydrocarbons or hydrogen passing through conduits in hydrogen generation apparatus;
(i) monitoring of changes in phase behaviour in two-phase synthesis reactions, such as formation of polymethacrylate or styrene-divinylbenzene (DVB), e.g., forming beads for chromatography;
(j) monitoring of changes in the physical parameters, such as size and/or morphology, of components or contaminants in the fluid in the conduit, e.g., the formation and/or presence of agglomerates in the fluid, e.g., agglomerates of proteins such as antibodies in the conduit, crystals in suspension (e.g., insulin) in the conduit; and
(k) monitoring of changes in physical parameters of fermentation reactions in vessels, such as production of alcohol (beer, wine, etc.) and some foodstuffs, for example, soya.

Applications (a), (d), (h) and (j) from the list above are particularly preferred. Additionally, or alternatively, embodiments of the invention are particularly suitable for process validation, e.g., Process Analytical Technology (PAT).

In more preferred embodiments, applications including monitoring two or more parameters via two or more emitters can be desirable so that processing conditions can be adjusted to allow one or more parameters to reach a set limit, predetermined value, or range of values. For example, if the change in concentration of one or more components reaches an undesirable value, one or more other monitored parameters (e.g., monitored at a different location and/or frequency) can be adjusted to allow the concentration of one or more components to reach or return to a desirable (e.g., predetermined) value or range of values. Alternatively, or additionally, one or more parameters can be monitored via ultrasound, and one or more other parameters and/or aspects (e.g., one or more of pH, nutrient feed, aeration, and agitation rate) can be monitored without using ultrasound, so that processing conditions can be adjusted to allow one or more parameters to reach a set limit, predetermined value, or range of values.

The following are some additional examples of applications in accordance with embodiments of the invention:

In fermentation or cell culture (e.g., in suspension, in perfusion, or in cell attached system) producing, for example, one or more of antibodies (e.g., monoclonal antibodies), proteins, peptides, recombinant proteins, plasmids, and viruses, ultrasound can be used to monitor one or more of the following in conduits: state of cells in suspension (agitation), cell growth rate, product (e.g., protein) expression level, aeration, nutrient feed, and agitation rate. As noted above, in more preferred embodiments, monitoring two or more parameters can be desirable so that processing conditions can be adjusted to allow one or more parameters to reach a predetermined value or range of values.

In accordance with embodiments of the invention, ultrasound can be utilized at a variety of points in processing the flowable material. For example, as part of a purification and/or separation process, e.g., including centrifugation, filtration, and/or chromatography, and/or at other points in processing, the process fluid passing through the conduit may be monitored by ultrasound.

After one or more of centrifugation, filtration (including, but not limited to, one or more of dead-end filtration, cross-flow filtration, diafiltration, sterile filtration, microfiltration and ultrafiltration) and chromatography, ultrasound can be used to confirm and/or control one or more of removal efficiency of unwanted contaminants (such as cells and cell debris) and the transmission level of the desired product(s). In some applications, the quick results obtained from utilizing ultrasound allow the processing system to be quickly optimized to provide increased cell concentration while reducing dilution and/or cell damage/product loss.

With respect to applications including filtration, in some embodiments of the invention, ultrasound can be used to measure, more preferably monitor and/or control, the presence or absence of product in the filtrate/permeate side conduit. With respect to applications including cross-flow filtration and/or diafiltration, in some embodiments of the invention, ultrasound can be used to measure, more preferably monitor and/or control, the concentration of product in the retentate side conduit and/or to measure, more preferably monitor and/or control, the presence or absence of product in the filtrate/permeate side conduit.

In all of the above applications, a series of ultrasound emitter units (and, optionally, a series of ultrasound receiver units) may be used instead of only a single unit. This means that the properties of the fluid inside the conduit may be measured at different points along the length of the conduit.

Using such an array of ultrasound units, it is possible to measure, more preferably monitor, changes in parameters and the propagation of these changes through a conduit. For example, when a fluid material having a high concentration of solute is diluted in a conduit, it is possible to monitor the diffusion of the solute through the fluid in the conduit, along with the concentration of the solute after dilution. Alternatively, for example, agglutination or dimerization, oligomerization and/or polymerization, e.g., the formation of agglomerates in the fluid, can be measured, e.g., detected and/or monitored, e.g., the formation of agglomerates increases attenuation, and causes the signal to drop. The start of agglomeration will cause noise, and thus the signal-to-noise (S/N) ratio will get smaller. As further agglomeration occurs, the S/N ratio will get lower. Thus, a drop in the S/N ratio (e.g., an increase in noise), suggests agglomeration. A further decrease in the S/N ratio (e.g., a further increase in noise) suggests more agglomeration. Ultrasound can be used to monitor, for example, in addition to the change in the S/N ratio, the viscosity increase (e.g., the concentration of agglomerates is proportional to the attenuation of the ultrasound) and/or the pressure increase associated with agglomeration.

In all of the above listed applications for the methods and apparatus, the changes can be observed over time, e.g., observed empirically over time. The present invention may be used to monitor fluid flows in real time and to indicate when changes occur in the fluid in the conduit. By comparison of the ultrasound signal recorded from a given conduit with previous signals recorded when certain features of the fluid material were changed, e.g., when milk soured or when a chemical product being eluted from a chromatography column was impure, these changes can be detected in real time when they occur again. This is especially useful for monitoring, for quality control purposes, a fluid product flowing through a conduit.

As well as monitoring the quality of a fluid product, embodiments of the methods and apparatus of the present invention are useful for monitoring the progress of a process upstream of the measurement site. In this situation, the ultrasound response of the fluid can be used to indicate, for example, when a process has reached completion, or has reached a certain stage. Embodiments of the invention are especially suitable for one or more of PAT, cGAMP, GxP-related analysis, and RMM.

Amplitude attenuation of the ultrasound signal is defined as the difference between the amplitude of the signal emitted from the ultrasound emitter and the amplitude of the ultrasound signal received by the ultrasound receiver after having passed through the fluid flow in the conduit.

Typically, ultrasound emitters and receivers are used, e.g., wherein the emitters and receivers are located on opposite sides of the conduit. However, in some embodiments, the ultrasound emitter and receiver are combined in an ultrasound transceiver. For example, the ultrasound signal is emitted from the transceiver, passes through the fluid flow, is reflected by an ultrasound reflector, passes back through the fluid flow, and is received by the ultrasound transceiver. Alternatively, for example, the ultrasound signal is reflected without an ultrasound reflector, e.g., the signal is reflected by a wall of the conduit.

Embodiments of the invention will now be described in detail, by way of example, with reference to the accompanying illustrative figures.

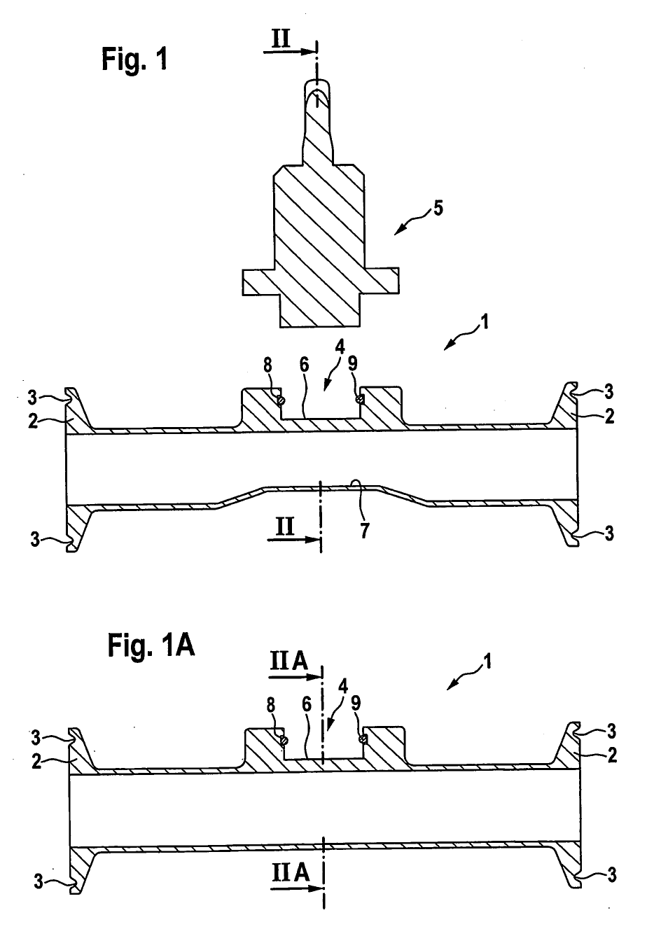

The embodiments illustrated in FIGS. 1 and 1A show a flow conduit 1. The illustrated conduit 1 has a connection flange 2 at each end, each with an O-ring seating 3, for connecting the conduit 1 to other parts of a flow system.

The illustrated flow conduit 1 in FIGS. 1 and 1A has an ultrasound transceiver socket 4 into which an ultrasound transceiver 5 may be inserted. The ultrasound transceiver socket 4 has a flat ultrasound transmission face 6 adjacent the wall of the conduit. Prior to insertion of an ultrasound transceiver 5 into the ultrasound transceiver socket 4 an amount of ultrasound transmissive material may be inserted into the ultrasound transceiver socket 4 on the ultrasound transmission face 6. This enhances the transmission of the ultrasound signal between an ultrasound transceiver 5 and the ultrasound transmission face 6.

The ultrasound transceiver socket 4 has a recess 8 in its side wall holding an O-ring 9. The O-ring 9 forms a seal against the outer surface of the transceiver 5 when it is inserted into the socket 4.

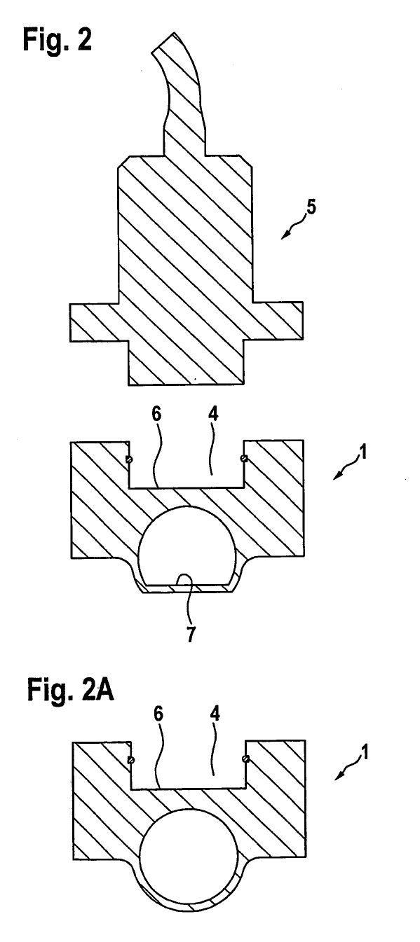

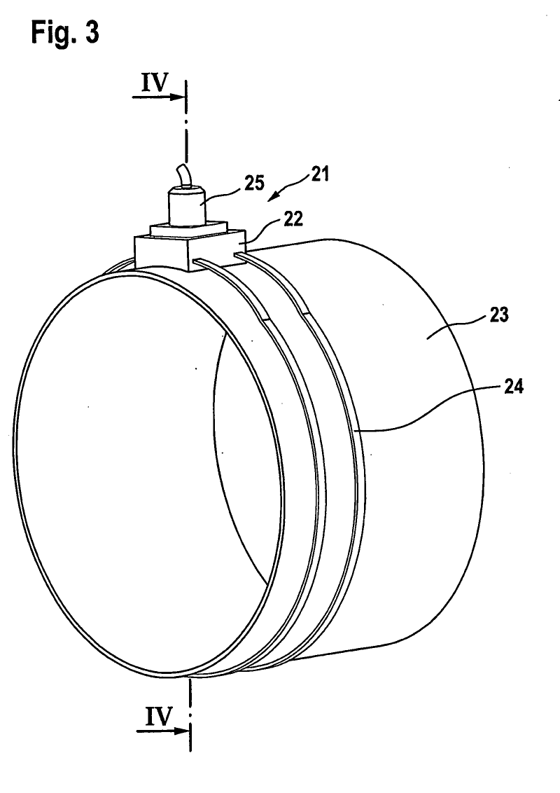

The flow conduit 1 illustrated in FIG. 1 also has an optional flat ultrasound reflector face 7 opposite the ultrasound transceiver socket 4. In some embodiments, the flat reflector face 7 provides a clearer ultrasound reflection than a curved wall of a typical conduit. The optional flat ultrasound reflector face 7 is shown more clearly in FIG. 2. However, in other embodiments (e.g., as shown in FIGS. 1A and 2A, as well as shown in conduit 23 in FIG. 3) the flow conduit has a curved wall without a flat portion and/or ultrasound reflector face, e.g., the signal is reflected by the curved wall of the conduit, or an ultrasound emitter and an ultrasound receivers are arranged to emit and receive signals without reflection.

In use, the flow conduit 1 is inserted in-line into a flow system and fluid flows through it. The flow conduit 1 has no preferred flow direction and so can be inserted into a flow system either way around.

When fluid is flowing through the conduit, an ultrasound transceiver 5 is inserted into the ultrasound transceiver socket 4 and is stimulated by a standard control apparatus (not shown) to emit an ultrasound signal at a characteristic frequency determined by the ultrasound transceiver 5 and the control apparatus. The ultrasound pulse is transferred to the ultrasound transmission face 6, optionally through an ultrasound transmissive material inserted between the ultrasound transceiver 5 and the ultrasound transmission face 6.

In some embodiments, the ultrasound signal travels through the fluid flowing through the conduit, is reflected from the ultrasound reflector face 7 as shown in FIG. 1 (or is reflected by the curved wall of the conduit (FIG. 1A)) and returns through the fluid for a second time. The reflected ultrasound signal is detected by the ultrasound transceiver 5 and the amplitude of the reflected signal is compared to that of the emitted signal and the attenuation of the amplitude of the ultrasound signal by the fluid is determined by signal processing apparatus (not shown).

Alternatively, for example, in those embodiments having a separate ultrasound emitter and ultrasound receiver (e.g., arranged on opposite sides of the conduit (not shown)), the received signal is detected by the ultrasound receiver and the amplitude of the reflected signal is compared to that of the emitted signal and the attenuation of the amplitude of the ultrasound signal by the fluid is determined by signal processing apparatus.

Changes in amplitude attenuation over time are then related, e.g., empirically related, to physical properties or processes in the fluid flowing through the conduit.

FIG. 2 shows a cross-section of FIG. 1 through II-II. This shows the shape of the illustrated embodiment of the conduit in cross-section more clearly and shows the alignment of the ultrasound reflector face 7 with the transmission face 6 of the ultrasound transceiver socket 4.

FIG. 2A shows a cross-section of FIG. 1A through IIA-IIA. This shows the shape of the illustrated embodiment of the conduit in cross-section more clearly.

FIG. 3 shows an ultrasound emitter unit 21, according to another embodiment of the invention, attached to a conduit 23. Conduit 23 has no preferred flow direction. A mounting block 22 is attached to the conduit 23 by straps 24 passing through the mounting block 22 and around the conduit 23. As the mounting block 22 is not attached to the conduit 23 in any other way, it can easily be detached from the conduit 23 or moved into another position, or maybe onto another conduit. FIG. 3 shows the mounting block 22 with the ultrasound emitter 25 in place in the socket.

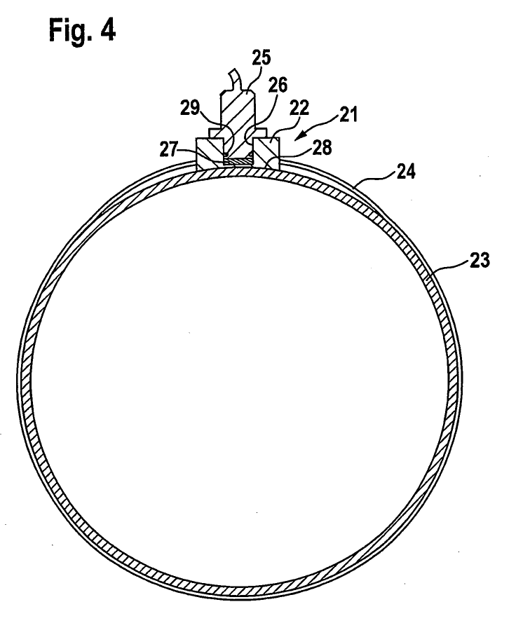

FIG. 4 shows a cross-section along IV-IV in FIG. 3. The mounting block 22 has a conduit interface surface 28 with a seal on it to provide a seal against the surface of the conduit 23. The mounting block 22 has an ultrasound emitter 25 in the socket 26. The ultrasound emitter 25 has a recess holding an O-ring 29 in the part which protrudes into the mounting block 22. This O-ring 29 provides a seal between the ultrasound emitter 25 and the mounting block 22.

An ultrasound transmissive gel 27 (couplant) is placed between the ultrasound emitter 25 and the surface of the conduit 23 against which the mounting block 22 is attached. This gel ensures a good transmission of the ultrasound signal between the ultrasound emitter 25 and the surface of the conduit 23.

The following example further illustrates the invention but, of course, should not be construed as in any way limiting its scope.

### Example 1

This example shows the use of attenuation of the amplitude of an ultrasound signal to detect of the concentration of protein passing through a conduit.

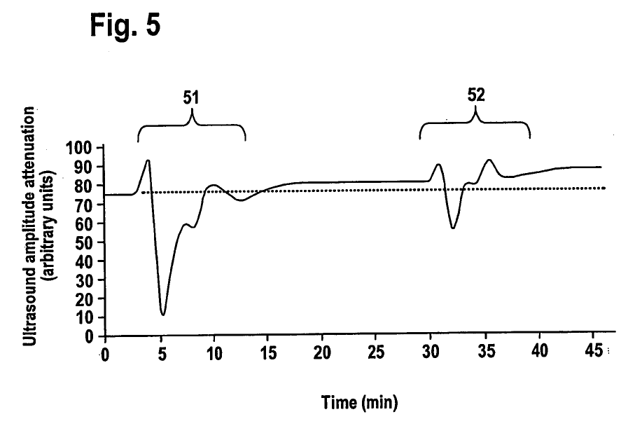

Two separate injections of 10 g/l albumin (1 litre and 0.5 litres) were applied at the same rate to a 400 mm diameter conduit. The albumin used was minimum 98% by agarose electrophoresis. In this case the conduit was packed with an agarose medium. The resultant ultrasound traces are shown in FIG. 5. Even though the conduit is packed with an agarose medium, as the medium does not change as the albumin sample passes through it, the conduit is effectively a pipe carrying process fluids.

FIG. 5 shows two peaks 51 and 52 in the ultrasound attenuation trace corresponding to the two injections of albumin into the flow conduit.

As the albumin samples are passed through the conduit, they are separated by the size and since the albumin consists of monomers and dimers, more than 1 peak is observed on the agarose medium, i.e., each sample is spread over the internal volume of the conduit. As the first sample 51 is double the volume of the second sample 52, 1000 ml as opposed to 500 ml, this results in the concentration of albumin at any given point in the conduit following the injection of the first sample 51 being double that following the injection of the second sample 52.

The ultrasound peak 51 shows slightly greater than double the amplitude attenuation of the peak 52 indicating that the amplitude attenuation of an ultrasound signal passed through a conduit can be used to indicate the concentration of a species (albumin) in the conduit.

In this case, the conduit packed with agarose medium acts as a slow-motion model for a conduit with a fluid flowing through it under laminar flow conditions, i.e., with a constant concentration of a species in the fluid flowing faster in the center and slower at the walls. As shown, this method can be used to detect different concentrations of a species in a conduit. Therefore, this Example shows the amplitude attenuation of an ultrasound signal can also be used to detect changes in concentration of a species during a fluid flow.

### Example 2

This example shows the use of attenuation of the amplitude of an ultrasound signal to detect of the concentration of a small molecule, acetone, at very low concentrations passing through a conduit.

A 400 mm diameter conduit was packed with an agarose medium to 250 mm. A 1 MHz transducer was placed at 9 cm from the bottom of the conduit.

Throughout the experiment the ultrasound returned signal from the 1 MHz transceiver was recorded via a control box then via an RS232 cable to a PC in the form of a csv (comma separated values) file. Ultrasound pulses were projected across the conduit by applying voltage to the piezo-electric crystal transceivers. A detector was used to monitor any reflected ultrasound signal on the crystal. The detector gave a readout as the change in amplitude of the reflected sound pulse. An automatic gain control (AGC) was used to change the gain to make the trace on the screen and on the output 80% full screen. Thus, the y-axis is that gain required to return the output signal to 80% maximum output, the x-axis is time.

A standard stock was prepared using a weighing balance (range 1 to 60 kg). Two hundred millilitres of acetone was added to about 15 litres of 0.2 μm filtered town water. The stock was then made to 20 kg in total by adding more water, resulting in a 10 ml/kg solution of acetone in water.

Using an injection loop system, with 0.5 inch tubing as the injection loop, 0.94 l of the 10 ml/kg standard was injected into the 400 mm diameter conduit packed with agarose medium. Even though the conduit is packed with an agarose medium, since the medium does not change as the acetone sample passes through it, the conduit is effectively a pipe carrying process fluids.

Once the 10 ml/kg was passed through the conduit; using the weighing balance on which the sample vessel sat, the acetone concentration was made to 8 ml/kg, by adding more water.

The injection loop was filled with this 8 ml/kg sample, and 0.94 l injected as was done with the 10 ml/kg sample.

Using the procedure described above, water/acetone concentrations of 6 ml/kg, 4 ml/kg and 2 ml/kg, were prepared and injected.

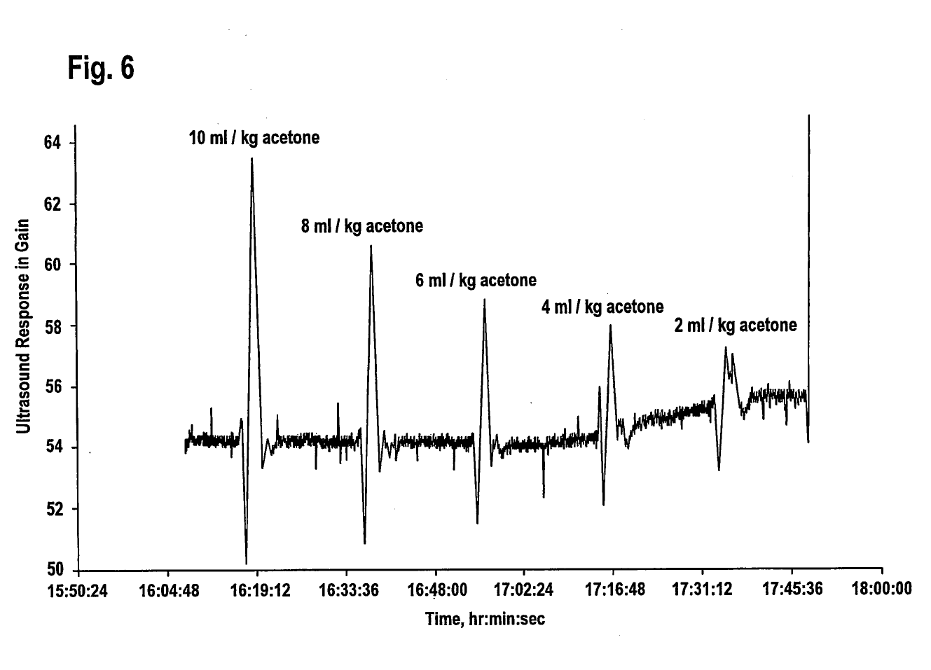

The resultant ultrasound traces are shown in FIG. 6. The increase in attenuation of the ultrasound after the 2 ml/kg trace was the result of air entering the conduit after the sample ran out.

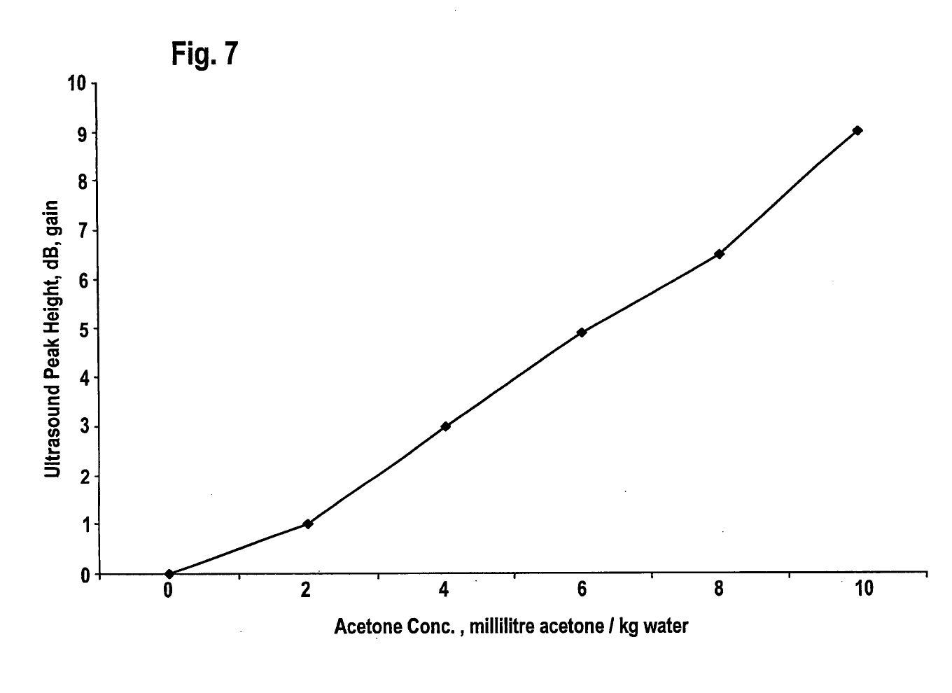

Once all 5 samples were observed the file was closed and converted to an Excel workbook. Using Excel the attenuation was plotted against the concentration and the resulting graph is shown in FIG. 7.

The graph suggests there is a linear relationship between acetone concentration and ultrasound attenuation.

In accordance with this Example, the sample passes though and is thus diluted by nearly 20 litres of the moving water in the conduit. This suggests a sensitivity to the species in the order of 0.1 or 0.2 ml in 20 litres. For example, a sensitivity of about 0.08 g/20000 g, or a sensitivity of about 5 ppm (part per million) for a molecule with a molecular weight of about 58 Daltons.

This Example shows embodiments of the method can be used to detect different concentrations of a species in a conduit, and that the amplitude attenuation of an ultrasound signal can also be used to detect changes in concentration of a species during a fluid flow.

Thus, in general the conduit to which embodiments of the present invention relate is not a chromatography column, as indicated by any one or more of: not containing a particulate bed; not causing separation of components; defining an open internal flow space; fluid flow unimpeded other than by boundary effects at the wall; having an internal space uninterrupted by solids-retaining liquid-permeable elements at any point; and typically being a pipe more than twice as long as its maximum transverse dimension.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A non-invasive method of measuring one or more parameters in a fluid flowing through a conduit, the method comprising:
transmitting ultrasound signals at a frequency in the range of from about 100 kHz to about 30,000 kHz through the fluid;
measuring amplitude attenuation of the ultrasound signals having passed through the fluid; and,
using the measured attenuation to measure a parameter in the fluid.

2. The method of claim 1, comprising measuring one or more of agglomerates, solutes, particulates, and precipitates, in the conduit.

3. The method of claim 1, comprising measuring one or more of fluid pressure, solute concentration, solid particulate concentration, purity of target molecule, and detection of target molecule, in the conduit.

4. The method of claim 1, comprising monitoring the fluid for the presence of agglomerates in the fluid in the conduit.

5. The method of claim 1, comprising monitoring solutes in the fluid in the conduit.

6. The method of claim 1, comprising monitoring fermentation in the fluid in the conduit.

7. The method of claim 1, comprising transmitting the ultrasound signal into the fluid in a metal conduit.

8. The method of any claim 1, comprising transmitting the ultrasound signal into the fluid in a plastic conduit.

9. The method of claim 1, further comprising adjusting fluid processing conditions to allow the one or more parameters in the fluid to reach a predetermined range of values.

10. The method of claim 1, comprising monitoring a change in a parameter of the fluid in the conduit including transmitting an ultrasound signal from two or more ultrasound emitters through the fluid in the conduit.

11. The method of claim 1, comprising monitoring a change in two or more parameters of the fluid in the conduit.

12. The method of claim 1, wherein monitoring a change in two or more parameters of the fluid in the conduit comprises transmitting an ultrasound signal from two or more ultrasound emitters into the fluid.

13. The method claim 1, wherein the ultrasound signal has a frequency of about 100 kHz to about 25,000 kHz.

14. The method of claim 1, wherein the ultrasound signal has a frequency of about 500 kHz to about 20,000 kHz.

15. The method of claim 1, wherein the ultrasound signal has a frequency of about 1,000 kHz to about 25,000 kHz.

16. The met hod of claim 1, wherein the ultrasound signal has a frequency of about 2,000 kHz to about 30,000 kHz.

17. The method of claim 16, wherein the conduit has a diameter in the range of from about 2 mm to about 6 mm.

18. The method of claim 14, wherein the conduit has a diameter in the range of from about 60 mm to about 150 mm.

19. The method of claim 15, wherein the conduit has a diameter in the range of from about 10 mm to about 50 mm.

20. The method of claim 13, wherein the conduit has a diameter in the range of from about 200 mm to about 2000 mm.

21. The method of claim 1, comprising monitoring fermentation without significantly reducing the presence of bubbles and/or foam in the fluid in the conduit.
